(19) United States
(12) Patent Application Publication
(10) Pub. No.: US 2008/0032238 A1
(43) Pub. Date: Feb. 7, 2008

(54) System and method for controlling the size and/or distribution of catalyst nanoparticles for nanostructure growth

(76) Inventors: Jennifer Q. Lu, Milpitas, CA (US); Nicolas J. Moll, Woodside, CA (US); Daniel B. Roitman, Menlo Park, CA (US); David T. Dutton, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/229,300

(22) Filed: Sep. 16, 2005

Related U.S. Application Data
(60) Provisional application No. 60/631,247, filed on Nov. 23, 2004.

(51) Int. Cl. B05D 7/22; G03C 5/00

(52) U.S. Cl. 430/322; 427/239; 430/330

(57) ABSTRACT

Techniques for controlling the size and/or distribution of a catalyst nanoparticles on a substrate are provided. The catalyst nanoparticles comprise any species that can be used for growing a nanostructure, such as a nanotube, on the substrate surface. Polymers are used as a carrier of a catalyst payload, and such polymers self-assemble on a substrate thereby controlling the size and/or distribution of resulting catalyst nanoparticles. Amphiphilic block copolymers are known self-assembly systems, in which chemically-distinct blocks microphase-separate into a nanoscale morphology, such as cylindrical or spherical, depending on the polymer chemistry and molecular weight. Such block copolymers are used as a carrier of a catalyst payload, and their self-assembly into a nanoscale morphology controls size and/or distribution of resulting catalyst nanoparticles onto a substrate.

### CROSS-REFERENCE TO RELATED APPLICATIONS

This application claims priority to U.S. Provisional Patent Application Ser. No. 60/631,247 entitled “METHOD FOR PRODUCING UNIFORMLY DISTRIBUTED NANOTUBES CATALYSTS ACROSS A SURFACE AND PATTERNING THE SAME”, filed Nov. 23, 2004, the disclosure of which is hereby incorporated herein by reference. This application is also related to U.S. patent application Ser. No. 10/766,639 entitled “NANOSTRUCTURES AND METHODS OF MAKING THE SAME”, filed Jan. 28, 2004, the disclosure of which is hereby incorporated herein by reference.

### BACKGROUND OF THE INVENTION

Carbon nanotubes (CNTs) have become the most studied structures in the field of nanotechnology due to their remarkable electrical, thermal, and mechanical properties. In general, a carbon nanotube can be visualized as a sheet of hexagonal graph paper rolled up into a seamless tube and joined. Each line on the graph paper represents a carbon-carbon bond, and each intersection point represents a carbon atom. In general, CNTs are elongated tubular bodies which are typically only a few atoms in circumference. The CNTs are hollow and have a linear fullerene structure. Such elongated fullerenes having diameters as small as 0.4 nanometers (nm) and lengths of several micrometers to tens of millimeters have been recognized. Both single-walled carbon nanotubes (SWCNTs) and multi-walled carbon nanotubes (MWCNTs) have been recognized.

CNTs have been proposed for a number of applications because they possess a very desirable and unique combination of physical properties relating to, for example, strength and weight ratio. For instance, CNTs are being considered for a large number of applications, including without limitation field-emitter tips for displays, transistors, interconnect and memory elements in integrated circuits, scan tips for atomic force microscopy, and sensor elements for chemical and biological sensing. CNTs are either conductors (metallic) or semiconductors, depending on their diameter and the spiral alignment of the hexagonal rings of graphite along the tube axis. They also have very high tensile strengths. CNTs have demonstrated excellent electrical conductivity.

Chemical vapor deposition (CVD) is becoming widely used for growing CNTs. In this approach, a feedstock, such as CO or a hydrocarbon or alcohol, is catalyzed by a transition metal catalyst to promote the CNT growth. Even more recently, plasma enhanced CVD (PECVD) has been proposed for use in producing CNTs, which may permit their growth at lower temperatures. Thus, in several production processes, such as CVD and PECVD, CNTs can be grown from a catalyst on a substrate surface, such as a substrate (e.g., silicon or quartz) that is suitable for fabrication of electronic devices, sensors, field emitters and other applications. For instance, using techniques as CVD and PECVD, CNTs can be grown on a substrate (e.g., wafer) that may be used in known semiconductor fabrication processes. In general, the catalyst includes nanoparticles therein from which nanotubes grow during the growth process (i.e., one nanotube may grow from each nanoparticle).

CNT growth using transition-metal catalyst nanoparticles in a CVD system has become the standard technique for growth of single-wall and multi-wall CNTs for substrate-deposited applications. Various catalyst systems have been developed for CVD growth, including iron/molybdenum/alumina films, iron nanoparticles formed with ferritin, nickel/alumina films, and cobalt-based catalyst films.

Key to many applications is the control of CNT size and placement on a substrate. Traditional nanotube growth methods suffer from the intrinsic inability to provide controllable and predictable carbon nanotube growth in terms of size and density. Prior proposed schemes are also very difficult to integrate into conventional semiconductor device fabrication methodology, especially when catalyst supports are used.

The catalyst determines almost every aspect of carbon nanotube growth. Thus, some work has focused on controlling the catalyst size. Recently, ferritin and dendrimers have been used as templates to trap iron catalyst particles. Even though the particle size control is improved in these techniques, it is inconceivable that iron catalyst particles will be uniformly distributed across a wafer without further aid, such as with the aid of a polymer binder. Dip coating of Poly(styrene-block-ferrocenylethylmethylsilane) has been proposed to form short-range ordered self-assembled structures, but long-range order has not been achieved in this manner.

Block polymers have been widely used as a template to generate a variety of nanostructures. Complexation of transition metals with an electron rich donor, such as oxygen and nitrogen, is a well known phenomenon and people have been able to prepare successfully a number of nanoparticles through complexation methods, for example, complexation of platinum or ruthenium onto the vinyl pyridine unit of PS-PVP block polymers.

There is a need for a method for providing more precise control over the size and relative positions of nanoparticle catalysts for CNT growth. Further, a desire exists for a high-yield process for controlling the size and relative positioning of catalyst nanoparticles on a substrate.

### SUMMARY OF THE INVENTION

As mentioned above, nanostructures, such as carbon nanotubes, are grown from catalyst nanoparticles on a substrate via a growth process such as CVD or PECVD. Embodiments of the present invention provide techniques for controlling the size and/or distribution (e.g., density, relative spacing, etc.) of such catalyst nanoparticles on a substrate. More particularly, techniques are provided in which polymers are used as a carrier of a catalyst payload, and such catalyst-containing polymers self-assemble on a substrate thereby controlling the size and/or distribution of the catalyst nanoparticles in a desired manner. In exemplary embodiments described herein, block copolymers capable of self-assembly are used as a carrier of catalyst species (e.g., atoms of a catalyst, such as iron, cobalt, nickel, etc.). The copolymers self-assemble to condense and arrange the catalyst species into a distribution of catalyst nanoparticles. The non-catalyst material (e.g., organic materials) are removed, leaving the catalyst nanoparticles remaining distributed on the substrate. Accordingly, the self-assembly of the polymers controls the size and distribution of the catalyst nanoparticles formed on the substrate.

While specific examples are provided herein for controlling size and distribution of catalyst nanoparticles for growing nanotubes, the concepts provided herein are not limited in application to catalyst nanoparticles for growth of nanotubes but may be applied for controlling the size and distribution of catalyst nanoparticles for growth of other nanostructures, such as nanofibers, nanoribbons, nanothreads, nanowires, nanorods, and nanobelts.

### BRIEF DESCRIPTION OF THE DRAWINGS

FIGS. 1A-1C show an exemplary diblock copolymer and various nanomorphologies into which such diblock copolymer can self-assemble based on the volumetric ratio of its blocks;

FIG. 2A shows an illustration of a spherical morphology of the diblock copolymer of FIG. 1A when formed in a sufficiently thin film, and FIG. 2B shows an illustration of a cylindrical morphology of the diblock copolymer of FIG. 1A when formed in a sufficiently thin film;

FIGS. 3A-3D show an exemplary method of fabricating a nanostructure on a substrate in accordance with one embodiment of the present invention;

FIG. 4A shows an exemplary coordination reaction for complexation of iron with pyridine units of polystyrene-b-poly(vinyl pyridine) (PS-b-PVP) in accordance with one embodiment;

FIG. 4B shows a representative AFM image of iron oxide nanoparticles obtained from a self-assembled cylindrical structure of the exemplary diblock copolymer of FIG. 4A;

FIG. 4C shows a SEM image of carbon nanotubes prepared from the iron oxide nanoparticles of FIG. 4B;

FIG. 4D shows a representative AFM image of nickel nanoparticles obtained from a self-assembled cylindrical structure of an exemplary diblock copolymer of polystyrene-b-nickel complex poly(vinyl pyridine) according to one embodiment;

FIG. 4E provides a table summarizing the carbon nanotube (CNT) results from various exemplary single and bimetallic catalyst nanoclusters produced from complexation with PS-b-PVP;

FIG. 5A shows an exemplary resulting structure of a coordination reaction for direct synthesis of polystyrene-b-poly(ferrocenylethylmethylsilane) (PS-b-PFEMS) in accordance with one embodiment;

FIG. 5B shows a representative AFM image of iron-containing nanoparticles obtained from a self-assembled cylindrical structure of the exemplary diblock copolymer of FIG. 5A;

FIG. 5C shows low and high-resolution SEM images of carbon nanotubes prepared from the iron-containing nanoparticles of FIG. 5B;

FIG. 5D shows Raman spectrum for the carbon nanotubes of FIG. 5C;

FIG. 6A shows high-frequency Raman analysis of carbon nanotubes produced from iron nanoparticles derived from iron complexed PS-b-PVP, such as the carbon nanotubes of FIG. 4C;

FIG. 6B shows high-frequency Raman analysis of carbon nanotubes produced from iron nanoparticles derived from PS-b-PFEMS, such as the carbon nanotubes of FIG. 5C;

FIGS. 7A-7C show an exemplary scheme for generation of catalyst cluster islands using conventional semiconductor patterning techniques in accordance with one embodiment of the present invention;

FIGS. 8A-8D show another exemplary approach that can be used to create patterned arrays of CNTs using conventional semiconductor patterning techniques in accordance with an embodiment of the present invention;

FIG. 9 shows exemplary SEM images of single-walled carbon nanotubes grown from patterned catalytic islands, such as the islands of FIG. 8E, at low magnification and high magnification (insert);

FIGS. 10A-10E show another exemplary application using conventional semiconductor patterning techniques with the polymer technique described herein for forming suspended CNTs in accordance with one embodiment of the present invention; and

FIG. 11 shows an SEM image of suspended CNTs obtained via the exemplary technique of FIGS. 10A-10E.

### DETAILED DESCRIPTION OF THE INVENTION

It is helpful at the outset hereof to provide an overview of some of the terminology used herein. The following overview of terminology will be a simple review for one of ordinary skill in the art, as the terminology used herein is not inconsistent with how it is commonly used in the art.

The term “polymer” refers to a chemical compound or mixture of compounds formed by polymerization and consisting essentially of repeating structural units. The basic chemical “units” that are used in building a polymer are referred to as “repeat units.” A polymer may have a large number of repeat units or a polymer may have relatively few repeat units, in which case the polymer is often referred to as an “oligomer.”

When a polymer is made by linking only one type of repeat unit together, it is referred to as a “homopolymer.” When two (or more) different types of repeat units are joined in the same polymer chain, the polymer is called a “copolymer.” In copolymers, the different types of repeat units can be joined together in different arrangements. For instance, two repeat units may be arranged in an alternating fashion, in which case the polymer is referred to as an “alternating copolymer.” As another example, in a “random copolymer,” the two repeat units may follow in any order. Further, in a “block copolymer,” all of one type of repeat unit are grouped together, and all of the other are grouped together. Thus, a block copolymer can generally be thought of as two homopolymers joined in tandem. A block copolymer can include two or more units of a polymer chain joined together by covalent bonds. A “diblock copolymer” is a block copolymer that contains only two units joined together by a covalent bond. A “triblock copolymer” is a block copolymer that contains only three units joined together by covalent bonds.

As described further herein, at least one of the repeat units of a polymer includes a “catalyst payload” in accordance with embodiments of the present invention. A “catalyst payload” refers to any species that can be used as a catalyst for growing a nanostructure on a substrate surface. The catalyst payload may be attached, such as by complexation, to the repeat unit of the polymer. Exemplary catalyst payloads include, without limitation, metal species, such as transition metal species (e.g., iron, molybdenum, cobalt, and nickel), or other metal species, such as gold, depending on the desired properties of the catalyst nanoparticles to be formed on the substrate's surface.

A polymer that may be processed to deliver the catalyst payload on the surface of a substrate is referred to herein as a “vector polymer.” That is, a “vector polymer” refers to a polymer that is processed to deliver the catalyst payload on the surface of a substrate. As described further herein, in embodiments of the present invention, such vector polymer self-assembles into a desired structure for controlling the size and/or distribution of catalyst nanoparticles produced by the catalyst payload carried by such vector polymer. Thus, the vector polymer self-assembles into a desired structure of catalyst-containing domains. The non-catalyst (e.g., organic) components of the vector polymer can then be removed, resulting in the catalyst nanoparticles remaining on the substrate with their size and/or distribution controlled by the vector polymer's self-assembly. While in certain exemplary embodiments described herein a diblock copolymer (A-B) is used as a vector polymer for carrying a catalyst payload, the scope of the present invention is not so limited. Rather, any polymer (e.g., triblock polymer, etc.) that is capable of self-assembly and in which at least one repeat unit thereof includes a catalyst payload may be utilized in accordance with the concepts presented herein. For instance, in certain embodiments a block copolymer A-B-A may be used. Further, in certain embodiments, a mixture of block copolymers (e.g., diblock copolymers) and homopolymers or a miscible blend of two homopolymers (A) and (B) is used to form a film containing self-assembling polymers. As an example, a diblock polymer and two homopolymers are used for forming the film containing self-assembling polymers.

Having provided a brief overview of the terminology used herein, attention is now directed to a discussion of embodiments of the present invention. Embodiments of the present invention provide techniques for controlling the size and/or distribution (e.g., density, relative spacing, etc.) of catalyst nanoparticles on a substrate. More particularly, techniques are provided in which polymers are used as carriers of catalyst payloads, and such polymers self-assemble on a substrate thereby controlling the size and/or distribution of the catalyst nanoparticles in a desired manner, and subsequently control the size and distribution of the nanostructures grown from such catalyst nanoparticles. In exemplary embodiments described herein, block copolymers capable of self-assembly are used as carriers of the catalyst payloads.

Amphiphilic block copolymers are known self-assembly systems, in which chemically distinct blocks microphase-separate into the periodic domains. The domains adopt a variety of nanoscale morphologies, such as lamellar, double gyroid, cylindrical, or spherical, depending on the polymer chemistry and molecular weight. Embodiments are described herein in which such amphiphilic block copolymers are used as carriers of catalyst payloads, wherein the self-assembly of the block copolymers into a desired nanoscale morphology results in a controlled arrangement of the catalyst nanoparticles formed from the carried catalyst payloads.

In certain embodiments, block copolymers are provided that include a block having catalyst atoms in higher oxidation states, such as atoms of a metal species, from which a nanostructure can be grown (e.g., via CVD or PECVD). In one example, a block has Fe2+ catalyst atoms, and in certain embodiments an oxidation process (e.g., UV-ozonation) is performed to remove organic components to result in Fe3+. Then an H₂ plasma treament is performed to reduce the catalyst atoms to Fe(0) for CNT growth.

The block that contains the catalyst payload is referred to as a payload-containing block. One or more of such payload-containing block is present in each block polymer. For instance, in certain embodiments a diblock copolymer is formed in which one block thereof is a payload-containing block, while the other block does not contain the catalyst payload. As described further herein, the block copolymers self-assemble on a substrate into a desired structure (i.e., a desired nanoscale morphology). The desired structure into which the block copolymers self-assemble controls the size and relative spacing of the catalyst nanoparticles formed from the carried catalyst payload.

Various exemplary techniques are described herein for forming block copolymers containing a catalyst payload. One exemplary technique involves complexation of a catalyst payload (e.g., catalyst atoms) with a block of a diblock copolymer. For instance, incorporation of a catalyst species, which may be a metal, such as iron, cobalt, and molybdenum, into one block of a diblock copolymer is accomplished by complexation of the catalyst atoms with the pyridine units of polystyrene-b-poly(vinyl pyridine) (PS-b-PVP). Another exemplary technique involves direct synthesis of a payload-containing diblock copolymer. For instance, sequential living polymerization of the nonmetal-containing styrene monomer followed by the catalyst-containing monomer of ferrocenylethylmethylsilane to form polystyrene-b-poly(ferrocenylethylmethylsilane) (PS-b-PFEMS) is an exemplary technique for direct synthesis of a catalyst-containing diblock copolymer.

By controlling the volume of each of the blocks (A and B) of the diblock copolymer, the structures into which the diblock copolymers arrange during their self-assembly can be controlled. That is, by controlling the volumetric ratio of one of the blocks of the diblock copolymer to the total volume of the diblock copolymer, the nanoscale morphology, such as lamellar, double gyroid, cylindrical, or spherical, into which the diblock copolymer self-assembles can be controlled. Accordingly, an appropriate volume of each of the blocks of a diblock copolymer is first determined based on the structure that is to be formed by the self-assembly process. That is, the ratio of the payload-containing block to the non-payload-containing block is determined for forming a desired structure, such as a hexagonal or spherical structure. The blocks are then deposited in the determined ratio onto a substrate surface as a thin film. An annealing process is then performed to cause the diblock copolymers to self-assemble into the desired structures. The desired structures into which the diblock copolymers self-assemble dictate the size and distribution (e.g., relative spacing) of the catalyst nanoparticles formed from the carried catalyst payloads. Further, this self-assembly technique provides a high yield as substantially all of the catalyst nanoparticles formed by the self-assembled diblock copolymers remain on the substrate after an oxidation process (e.g., UV-ozone or oxygen plasma) treatment is performed to remove the organic component, as described further herein.

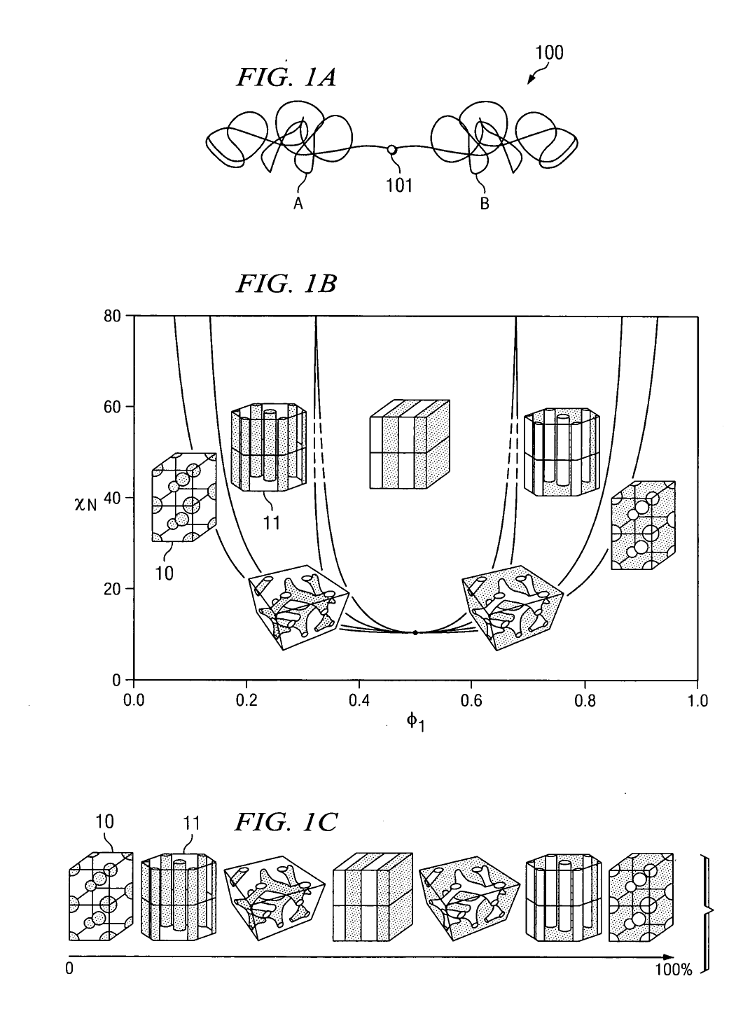

Turning first to FIGS. 1A-1C, self-assembly via morphology of symmetric amorphous diblock copolymers into a desired structure is briefly described. Again, such self-assembly of diblock copolymers is known, and is briefly described herein to conveniently aid the understanding by the reader of the exemplary embodiments described further herein. FIG. 1A shows an exemplary amphiphilic diblock copolymer 100 that includes immiscible blocks A and B that are linked via covalent bond 101.

FIG. 1B shows a graph illustrating a block copolymer phase diagram. As shown, one axis of the graph corresponds to a range of _{X}N, where _{X} is the Flory-Huggins interaction parameter and N is the number of repeat units, and the other axis of the graph corresponds to a range of φ₁, which is the volume fraction of block A in the copolymer. As is known,

$$χ = [ \frac{{E}_{AB} - \frac{1}{2} ( {E}_{AA} + {E}_{BB} )}{{k}_{B} T} ] ,$$

where _{X} is the Flory-Huggins interaction parameter, E_{AB} is the interaction energy between block A and block B, E_{AA} is the interaction energy between block A, and block A, E_{BB} is the interaction energy between block B and block B, k_{B} is Boltzman's constant, and T is temperature. The phase-separation in microscale, illustrated in this figure requires two chemically distinct blocks of a polymer chain joined together by a covalent bond, such as the chemically distinct blocks A and B joined by covalent bond 101 in FIG. 1A. The covalent bond prevents macrophase separation.

FIG. 1C shows the various structures (nanomorphologies) into which the diblock copolymer 100 of FIG. 1A self-assembles as the volumetric ratio of block A to the total volume of block A and block B increases. That is, the volumetric ratio of block A in diblock copolymer 100 is

$$volumetric\_ratio = \frac{{V}_{A}}{( {V}_{A} + {V}_{B} )} .$$

Thus, as FIG. 1C illustrates, the structure into which the diblock copolymer 100 self-assembles can be controlled by controlling the volumetric ratio of block A in diblock copolymer 100. For instance, as FIGS. 1B-1C illustrate, the diblock copolymer 100 self-assembles into a spherical morphology 10 when the volume of block A is in the range of approximately 0-21% of the volume of the diblock copolymer. In this case, the minority block A self-assembles into uniformly distributed spheres, as shown. As another example, the diblock copolymer 100 self-assembles into a cylindrical morphology 11 when the volume of block A is in the range of approximately 21-34% of the volume of the diblock copolymer. In this case, the minority block A self-assembles into uniformly distributed cylinders, as shown.

Embodiments of the present invention leverage the above-described self-assembly of diblock copolymers to control the size and/or distribution of catalyst nanoparticles on a substrate. More particularly, a catalyst payload is included in at least one of the blocks of a diblock copolymer (e.g., blocks A and B of FIG. 1A), and the self-assembly of such diblock copolymer into a desired structure controls the size and/or distribution of catalyst nanoparticles produced from such catalyst payload. For instance, a catalyst payload is included in the block A of diblock copolymer 100 in the above examples, and the volumetric ratio of block A in diblock copolymer 100 is selected to control the self-assembled structure, and thus control the size and/or distribution of the catalyst nanoparticles formed thereby on a substrate. For example, by selecting a volumetric ratio of the minority block A to be in the range of approximately 0-21% to that of (V_{A}+V_{B}), the minority block A, which contains the catalyst payload, will self-assemble into the spherical morphology 10. That is, the payload-containing block A will self-assemble into the uniformly distributed spheres, as in structure 10. As another example, by selecting a volumetric ratio of minority block A to be in the range of approximately 21-34% to that of (V_{A}+V_{B}), the minority block A, which contains the catalyst payload, will self-assemble into the cylindrical morphology 11. That is, the payload-containing block A will self-assemble into the uniformly distributed cylinders, as in structure 11.

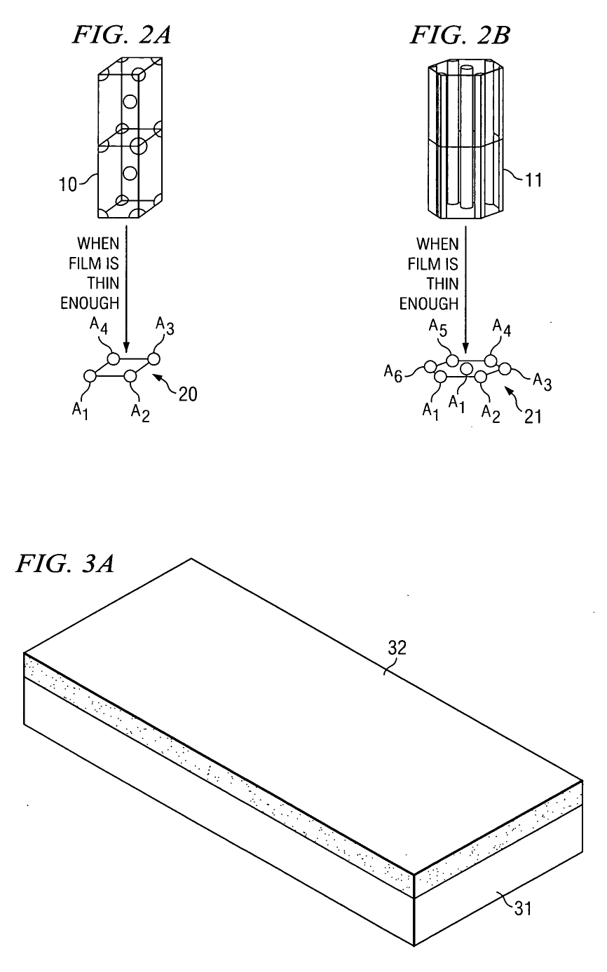

As described further herein, the vector polymer is deposited as a film onto a substrate, and thereafter a process that promotes self-assembly (e.g., annealing) is performed to cause the vector polymer to self-assemble into the appropriate structure based on the volumetric ratio of block A in the vector polymer. By controlling the thickness of the film, the size and distribution of the catalyst nanoparticles produced by the carried catalyst payload is further controlled. For instance, FIG. 2A illustrates that when the film is sufficiently thin, the spherical morphology 10 results in structure 20, which is a single layer (i.e., a thin cross-section) of such spherical morphology and contains payload-containing blocks A₁, A₂, A₃, and A₄. Similarly, FIG. 2B illustrates that when the film is sufficiently thin, the cylindrical morphology 11 results in structure 21, which is a thin cross-section of the cylindrical morphology and contains payload-containing blocks A₁, A₂, A₃, A₄, A₅, A₆, and A₇.

The substrate's physical and chemical properties, as well as the film thickness, are controlled to ensure that the cylinder will be perpendicular to the substrate's surface. In certain embodiments, the film thickness is selected as less than or equal to half the periodicity of the self-assembled structures (e.g., cylinders, etc.) desired between the catalyst nanoparticles formed by the payload-containing blocks. If the film is too thick, the structures (e.g., cylinders) will extend parallel to the substrate surface instead of being perpendicular to the substrate surface. It should be recognized that having the cylinders formed perpendicular to the surface of the substrate rather than extending parallel to the surface aids in controlling spacing of the catalyst nanoparticles, and this is important for generating discrete nanoparticles. In certain embodiments, the film thickness is adjusted to equal to or less than half the periodicity. This is done to facilitate self-assembly. Of course, in other embodiments, the film thickness may be greater than the domain periodicity.

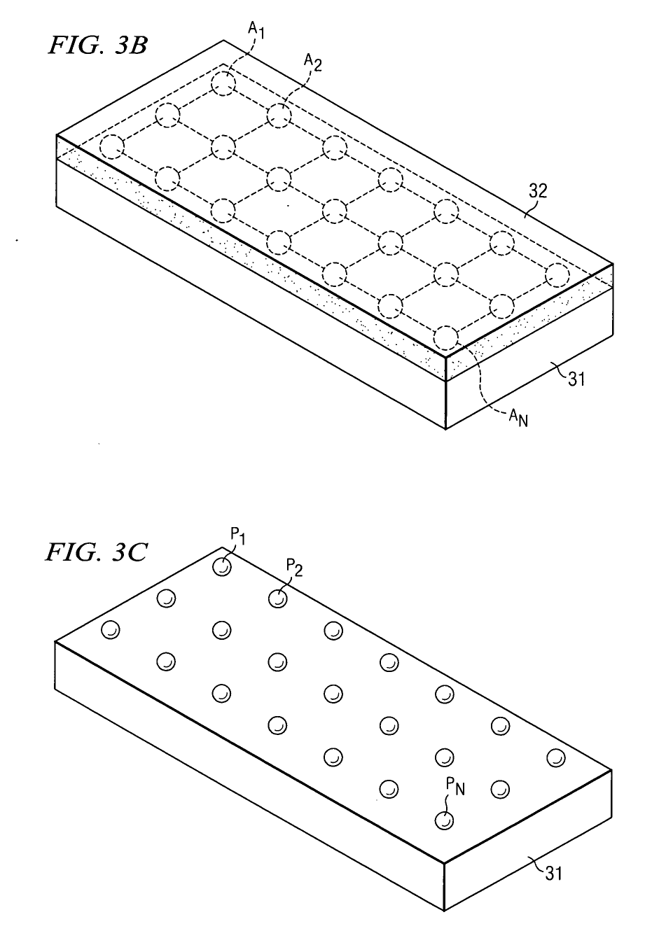

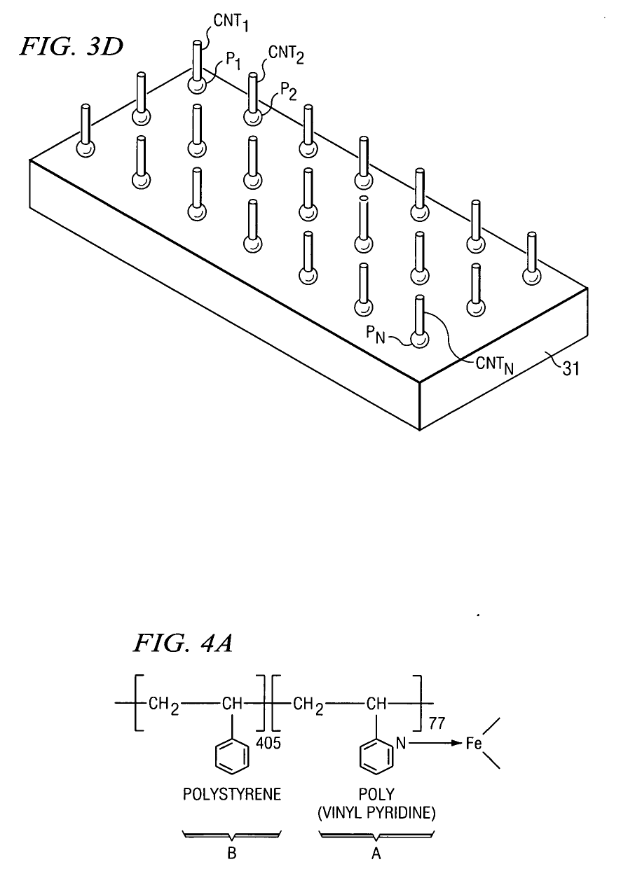

FIGS. 3A-3D show an exemplary method of fabricating a nanostructure on a substrate in accordance with one embodiment of the present invention. In FIG. 3A, a film 32 is formed on a substrate 31. Film 32 may be formed on substrate 31 by spin-casting, as an example. The substrate 31 may be any type of substrate that is compatible with the processes described herein. Exemplary substrate materials include silicon, alumina, quartz, silicon oxide, and silicon nitride. Film 32 includes a vector polymer that has a predetermined volumetric ratio of the respective blocks thereof. In an example, the vector polymer is the exemplary diblock copolymer 100 shown in FIG. 1A having a predetermined volumetric ratio of blocks A and B for self-assembling into a desired structure, such as the spherical morphology 10 or the cylindrical morphology 11. Further, at least one of the blocks of the vector polymer includes a catalyst payload. For instance, in the exemplary diblock copolymer 100 of FIG. 1A, the block A includes the catalyst payload. In certain embodiments, the catalyst payload is included in the minority block, and again the volumetric ratio of such minority block within the diblock copolymer 100 controls the structure into which the vector polymer will self-assemble.

As shown in FIG. 3B, the film 32 is then annealed to promote self-assembly into periodic nanostructures within such thin film. In the illustrative example shown, the vector polymer self-assembles into a spherical morphology that includes payload-containing blocks A₁, A₂, . . . , Aₙ distributed according to such spherical morphology. That is, the payload-containing blocks A₁, A₂, . . . , Aₙ self-assemble into uniformly distributed spheres, as shown. This assumes a certain film thickness, as mentioned above. In this example, the spheres are arranged in a square array.

As shown in FIG. 3C, an oxidation process, such as UV-ozonation, is performed to remove organic components and convert nonvolatile inorganic species into inorganic oxides. Thus, as a result of such UV-ozonation, the catalyst payloads (e.g., catalyst nanoparticles) P₁, P₂, . . . , Pₙ, such as iron oxide, carried by the payload-containing blocks A₁, A₂, . . . , Aₙ, respectively, remain on the substrate 31. The catalyst nanoparticles P₁, P₂, . . . , Pₙ are arranged on substrate 31 in accordance with the self-assembled structure of the vector polymer. That is, the catalyst nanoparticles P₁, P₂, . . . , Pₙ are uniformly distributed just as the payload-containing blocks A₁, A₂, . . . , Aₙ were distributed (in FIG. 3B) as a result of the self-assembly. As shown in FIG. 3D, a carbon nanotube growth process, such as CVD or PECVD, is carried out, resulting in growth of carbon nanotubes CNT₁, CNT₂, . . . , CNₙ from the catalyst nanoparticles P₁, P₂, . . . , Pₙ, respectively. While the catalyst nanoparticles P₁, P₂, . . . , Pₙ are used in this example to grow carbon nanotubes, in other applications catalyst nanoparticles may be distributed on a substrate surface in this manner and used to grow other desired nanostructures.

It should be recognized that for ease of illustration the FIGS. 3A-3D are not drawn to scale. However, FIGS. 3A-3D illustrate an example of the self-assembly concept for use in controlling the size and distribution of the catalyst nanoparticles P₁, P₂, . . . , Pₙ. That is, depending on volumetric ratio of the payload-containing blocks within a block copolymer, the structure into which the payload-containing blocks self-assemble can be controlled. As described above, the block copolymers microphase separate to form self-assembled structures, which dictates the size and distribution (e.g., relative spacing) of the catalyst nanoparticles formed by the carried catalyst payloads. Such self-assembly can be performed over a large surface area, and thus this process can be used for coating 3-inch, 16-inch, or any other size of wafer. Accordingly, uniform distribution and size in the catalyst nanoparticles can be achieved across a relatively large substrate (e.g., across the surface of a wafer). Actual Atomic Force Microscope (AFM) images of exemplary catalyst nanoparticles that are distributed by exemplary self-assembled polymers are shown and described later herein, which verifies the ability of achieving uniformly distributed and sized catalyst nanoparticles across a substrate using this self-assembly technique.

As mentioned above, a catalyst payload is included in at least one block of a vector polymer. Various exemplary techniques are described herein for forming block copolymers that have at least one block containing a catalyst payload. One exemplary technique involves complexation of a catalyst payload (e.g., atoms of a catalyst species) with a block of a diblock copolymer.

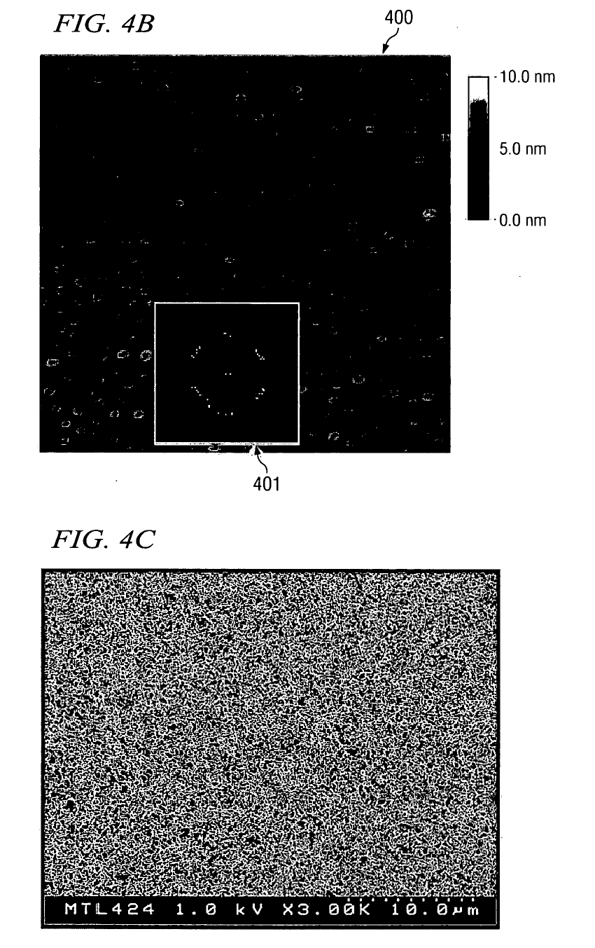

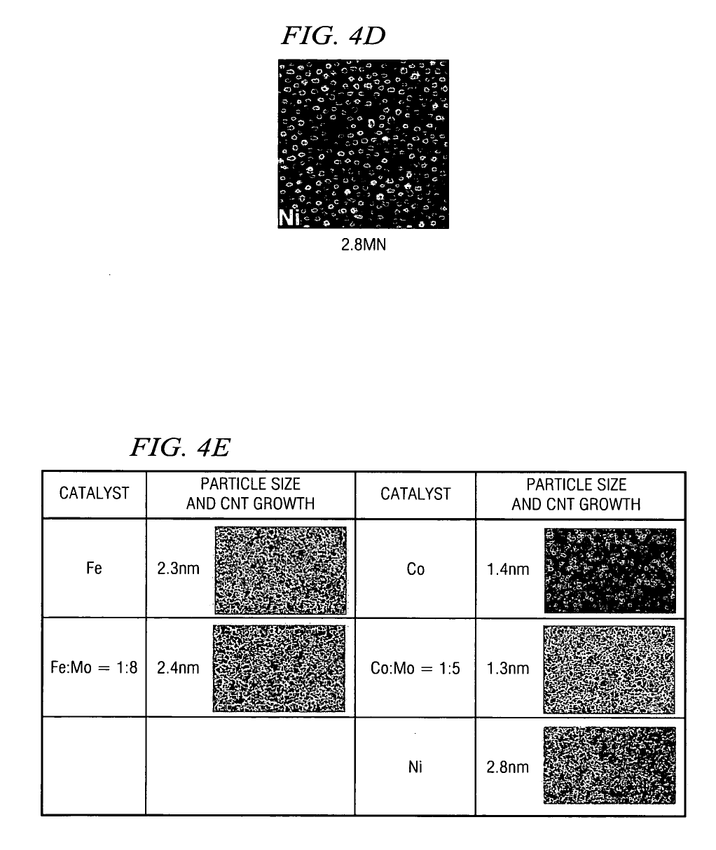

As an example of this complexation technique, a metal, such as iron, cobalt or molybdenum, is selectively incorporated into one repeat unit (a “block” is generally a group of repeat units) of a diblock copolymer by the complexation of the metal species with the pyridine monomers of polystyrene-b-poly(vinyl pyridine) (PS-b-PVP). Transition metals such as iron, cobalt, molybdenum, and nickel have energetically-accessible d orbitals. This partially filled outer electronic orbital structure provides a number of reaction pathways. To satisfy the 18 electron rule, the empty orbitals of the metals complex with electron-rich pyridine units of the PS-b-PVP. The proposed coordination reaction is shown in FIG. 4A. Annealing spin-coated thin films followed by subsequent UV-ozonation yields catalysts with controlled size and spacing. Exemplary catalysts that may result from this process include such catalysts as Fe, FeMo, Co, CoMo. FIG. 4B is a representative AFM image of iron oxide nanoparticles obtained from a self-assembled cylindrical structure of Poly(styrene-b-Iron-complexed vinylpyridine). The AFM image of FIG. 4B shows iron oxide nanoparticles deposited on a substrate following the above-described self-assembly and oxidation (e.g., UV-ozonation or oxygen plasma) of the PS-b-PVP complexed with iron of FIG. 4A. In this example, the volumetric ratio of the iron-containing block within the diblock copolymer was selected such that the iron-containing minority block self-assembled into uniformly distributed cylindrical structures, such as structure 21 of FIG. 2B. Thus, the iron oxide nanoparticles are uniformly distributed and have an average size of 2.3 nanometers (nm). The 2D Fourier Transform analysis insert 401 in the AFM image 400 of FIG. 4B clearly indicates a high degree of order of the nanoparticles. X-ray photoelectron element analysis confirmed that nanoparticles on the surface are indeed iron oxide.

FIG. 4C is a scanning electron microscope (SEM) image of carbon nanotubes prepared from the iron oxide nanoparticles of FIG. 4B. FIG. 4C illustrates that with the above-described polymer carrier approach, carbon nanotubes can be formed uniformly distributed on the substrate's surface.

Thus, in certain embodiments, catalyst metal species are incorporated in the form of organometallic complexes. For example, Fe, Co, or Mo can be complexed onto the vinyl pyridine unit of Poly(styrene-b-vinylpyridine) copolymer, as described above. As another example, Co and/or Fe can be complexed with the ethylenimine unit of poly(ethylenimine). Each repeat unit of a payload-containing block of a block copolymer can include one or more catalyst metal specie, such as Fe, Co, or Mo. Two different metal species can be incorporated into a repeat unit by first adding the less reactive one of the species (e.g., Fe) and then adding the more reactive one (e.g., Co).

FIG. 4D is a representative AFM image of nickel nanoparticles obtained from a self-assembled cylindrical structure of Poly(styrene-b-Nickel complexed vinylpyridine). The AFM image of FIG. 4D shows nickel nanoparticles formed on a substrate following the above-described self-assembly and oxidation of the PS-b-PVP complexed with nickel. In this example, the volumetric ratio of the nickel-containing block within the diblock copolymer was selected such that the nickel-containing minority block self-assembled into uniformly distributed cylindrical structures, such as structure 21 of FIG. 2B. Thus, the nickel nanoparticles are uniformly distributed and have an average size of 2.8 nanometers (nm) with periodicity of 32 nm in this experiment.

FIG. 4E is a table showing various catalysts that are complexed with PS-b-PVP in the manner described above for iron and nickel, corresponding average particle sizes of the catalyst nanoparticles resulting on the substrate (following the above-described self-assembly and UV-ozonation), and the corresponding SEM images of carbon nanotubes grown from such catalyst nanoparticles. Thus, the table of FIG. 4E summarizes the carbon nanotube (CNT) results from various single- and bi-metallic catalyst nanoclusters produced from the above-described complexation method. Even though CNT growth conditions were not optimized for the exemplary experiments illustrated in FIG. 4E, high-density carbon nanotubes were produced from these catalyst systems. This set of results indicates that all catalysts derived from the polymer-based complexation approach are effective catalysts for CNT growth and are able to form uniformly distributed CNTs over a large surface area, as shown in the SEM images in the table of FIG. 4E.

Other examples of block copolymers that can be formed through the above-described complexation technique include, but are not limited to, Poly(styrene-b-sodium acrylate), Poly(styrene-b-ethylene oxide), Poly(4-styrenesulfonic acid-b-ethylene oxide), Poly(isoprene(1, 4 addition)-b-vinyl pyridine), Poly(isoprene(1, 4 addition)-b-methylmethacrylate), Poly(styrene-b-acrylic acid), Poly(styrene-b-acrylamide), Poly(styrene-b-methylmethacrylic acid), and Poly(styrene-b-butyl acrylate). Of course, catalyst-containing block copolymers formed through complexation are not limited to those identified above. Rather, the above-identified catalyst-containing block copolymers are intended merely as examples.

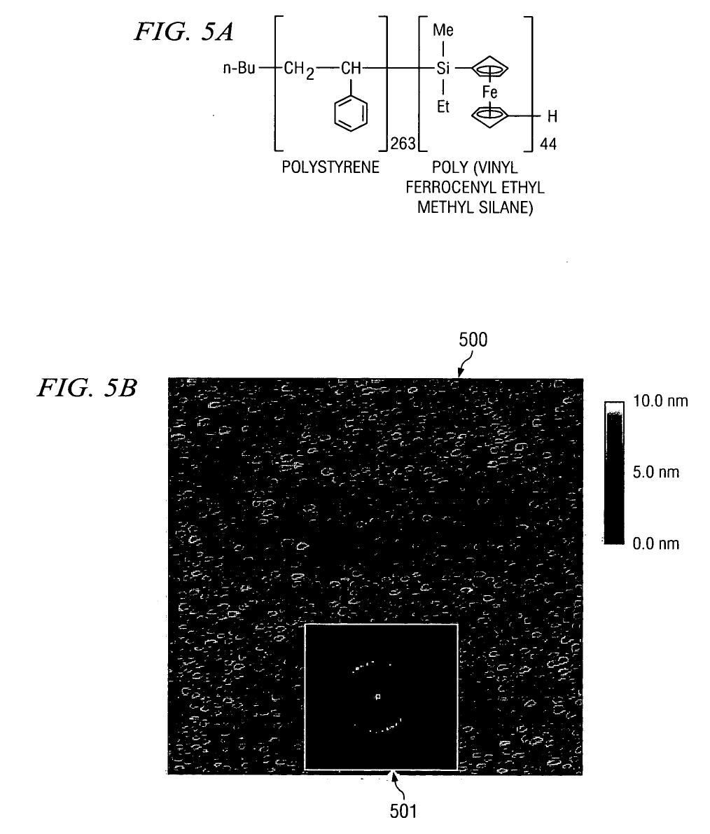

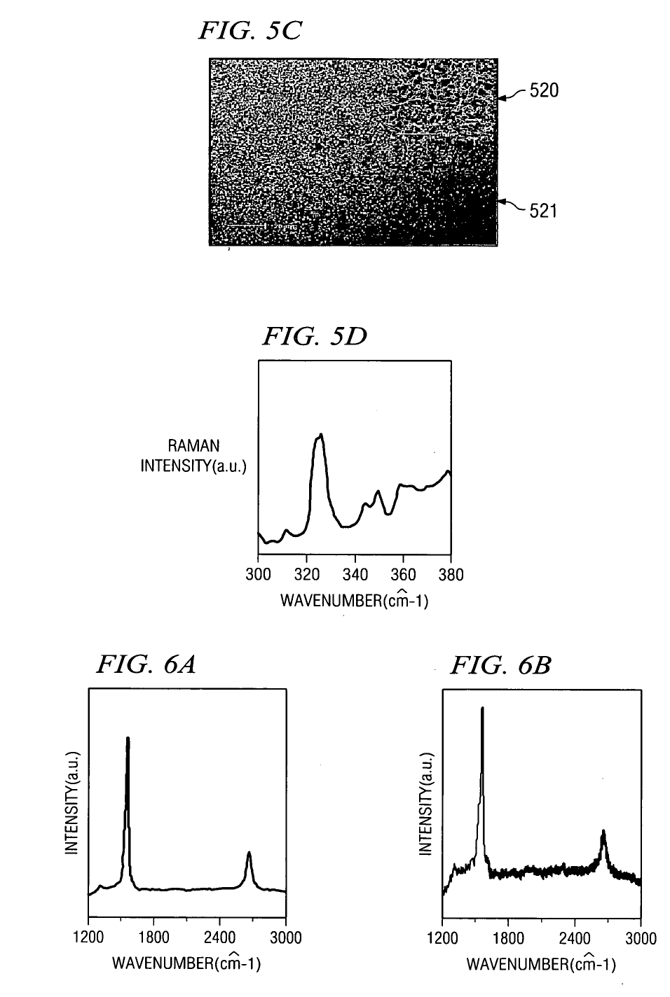

Another exemplary technique for forming block copolymers containing a catalyst payload involves direct synthesis of a payload-containing diblock copolymer. For instance, sequential living polymerization of the nonmetal-containing styrene monomer followed by the catalyst-containing monomer of ferrocenylethylmethylsilane to form polystyrene-b-poly(ferrocenylethylmethylsilane) (PS-b-PFEMS) is an exemplary technique for direct synthesis of a catalyst-containing diblock copolymer. A resulting structure of the proposed coordination reaction is shown in FIG. 5A.

In experiments, films of PS-b-PFEMS, synthesized by sequential living polymerization, were able to self-assemble into a periodically-ordered hexagonal morphology where cylindrical PFEMS domains were embedded in a PS matrix oriented perpendicular to the substrate, as identified by small angle X-ray scattering. Oxidation (e.g., UV-Ozone treatment) was carried out to remove organic components and convert nonvolatile inorganic components into SiO₂ and Fe₂O₃. FIG. 5B is a representative AFM image of iron-containing nanoparticles that resulted on a substrate following the above-described self-assembly and oxidation of the PS-b-PFEMS of FIG. 5A. In this example, the volumetric ratio of the iron-containing block within the diblock copolymer was selected such that the iron-containing minority block self-assembled into uniformly-distributed cylindrical structures, such as structure 21 of FIG. 2B. The AFM image 500 and inserted 2D Fourier Transform analysis 501 shown in FIG. 5B indicates that the iron-containing nanostructures have uniform size and periodicity.

Other examples of block copolymers that can be formed through the above-described direct synthesis technique include, but are not limited to, polymethylmethacrylate-b-polyferrocenylethylmethylsilane, polyisoprene-b-polyferrocenylethylmethylsilane, polydimethylsiloxane-b-polyferrocenylmethylethylsilane, polystyrene-b-polyferrocenylethylmethylsilane. Of course, catalyst-containing block copolymers formed through direct synthesis are not limited to those identified above, but rather these are intended merely as examples.

Both high and low magnification SEM images, as shown in FIG. 5C, depict a uniformly-distributed CNT network produced from a catalytically-active iron-containing inorganic nanostructure derived from PS-b-PFEMS. Due to excellent processability, evenly-distributed CNTs have been obtained using polymer-based catalyst systems. The Raman spectrum in FIG. 5D shows that CNTs with diameter less than 1 nm can be generated. The inventors hypothesize that iron-rich clusters surrounded by SiO₂ limit the mobility and coalescence of clusters at the growth temperature resulting in smaller-diameter CNTs than previously reported using conventional CVD methods.

Exemplary experiments utilizing the above-described self-assembly of polymers will now be described. In these exemplary experiments, diblock copolymers that include a payload-containing block were formed using either the complexation or the direct synthesis techniques described above. More particularly, selective incorporation of metal such as iron, cobalt, molybdenum, and nickel onto one block of a diblock copolymer was accomplished either by the complexation of metal with the pyridine of polystyrene-b-poly(vinyl pyridine) (PS-b-PVP) or by the sequential living polymerization of the nonmetal-containing styrene monomer followed by the catalyst-containing monomer of ferrocenylethylmethylsilane to form polystyrene-b poly(ferrocenylethylmethylsilane) (PS-b-PFEMS). Catalyst-containing polymer films, such as film 32 in FIG. 3A, with thickness ranging from 10 nm to 20 nm were prepared by spin casting toluene solutions at 4000 rpm for 30 seconds onto quartz substrates and onto silicon substrates covered with 500 nm of thermal oxide. After coating, the samples were annealed to induce self-assembled periodic nanostructures within the thin films, such as in FIG. 3B. UV-ozonation was then carried out to remove organic components and convert nonvolatile inorganic species into inorganic oxides, such as in FIG. 3C.

Various embodiments of the present invention are compatible with standard semiconductor processing techniques, such as photolithography and e-beam lithography techniques. Experiments demonstrate that photolithography techniques can be used to control the size and distribution of nanostructures on a microscale, while the above-described polymer self-assembly technique is used to control the size and distribution of nanostructures on a nanoscale. For instance, a polymer film carrying a catalyst payload may be deposited on a substrate, as described above, and such polymer film may be processed using photolithography to form “islands” of the polymer film. Such islands have a size and distribution that is controllable to an accuracy provided by the photolithography technique used. This accuracy is generally on a microscale. The polymer film is then annealed to cause the polymer material to self-assemble into a desired structure (e.g., cylindrical structure, etc.) as described above. Such self-assembly may be performed before or after the above-mentioned photolithography process is used to form the islands. Thus, the islands may be created on a substrate with micro-scale accuracy in their size/distribution, and the self-assembly technique may be used to control the size/distribution of catalyst nanoparticles within each island.

In one experiment, a bilayer lift-off process using a polymethylglutarimide (“PMGI”), such as Shipley™ LOL1000 as an underlayer and OCG 825 as an imaging layer were used to lithographically control the growth of CNTs. After lithographically defining resist patterns on a thermally-oxidized Si substrate, the PS-b-PFEMS diblock copolymer was deposited by spincoating and was annealed under toluene vapor. A solvent lift-off process was then performed, which left catalyst islands in the selected areas defined by photolithography. UV-Ozone treatment removed the organic matrix, leaving posts of iron oxide embedded in silicon oxide. The carbon nanotube growth was carried out in a CVD system as described previously.

Two types of substrates, one with patterning and one without were heated to 900° C. under H₂. Subsequently, a mixture of CH₄ and C₂H₄ was added to the gas flow to initiate carbon nanotube growth. The growth time was 10 minutes for the unpatterned substrates and 5 minutes for the patterned substrates.

The results of the above experiment revealed that use of diblock copolymers comprising two covalently linked, immiscible polymer blocks that undergo self-assembly in the solidstate afford well-defined arrays of nanostructures dictated by the polymer architecture and molecular weight. By choosing the right component and composition of a block copolymer, cylindrical and spherical morphologies can be observed. When the minority block of a diblock polymer contains metal, a periodic metal-containing polymeric nanostructure can be formed in a polymeric matrix having a non-metal containing majority block of the diblock polymer. After oxidation, the periodic catalytically active nanostructure can thus be formed.

High frequency Raman analysis, such as shown in FIGS. 6A and 6B, was used to evaluate the quality of CNTs produced from iron nanoparticles and iron-containing nanostructures derived from iron complexed PS-b-FePVP and PS-b-PFEMS, respectively. The D band at 1380 cm⁻¹ is the second-order defect-induced Raman mode involving a one-phonon scattering process. Thus, the intensity of this peak is directly correlated with the level of defects or dangling bonds in the sp² arrangement of graphene. The G band centered at 1590 cm⁻¹ is the first-order Raman process attributed to an in-plane oscillation of carbon atoms in the sp² graphene sheet. The very low intensity of the D band signal, and narrow width and high intensity of the G band signal indicate that CNTs produced by both systems have very low defect and dangling bond density. This is also supported by the strong intensity of the D* band (shown at 2760), which is the result of an inelastic two phonon double resonance emission process. The high D*/D ratios in both spectra indicate that the CNTs possess high quality with a minimal amount of amorphous carbon and defects.

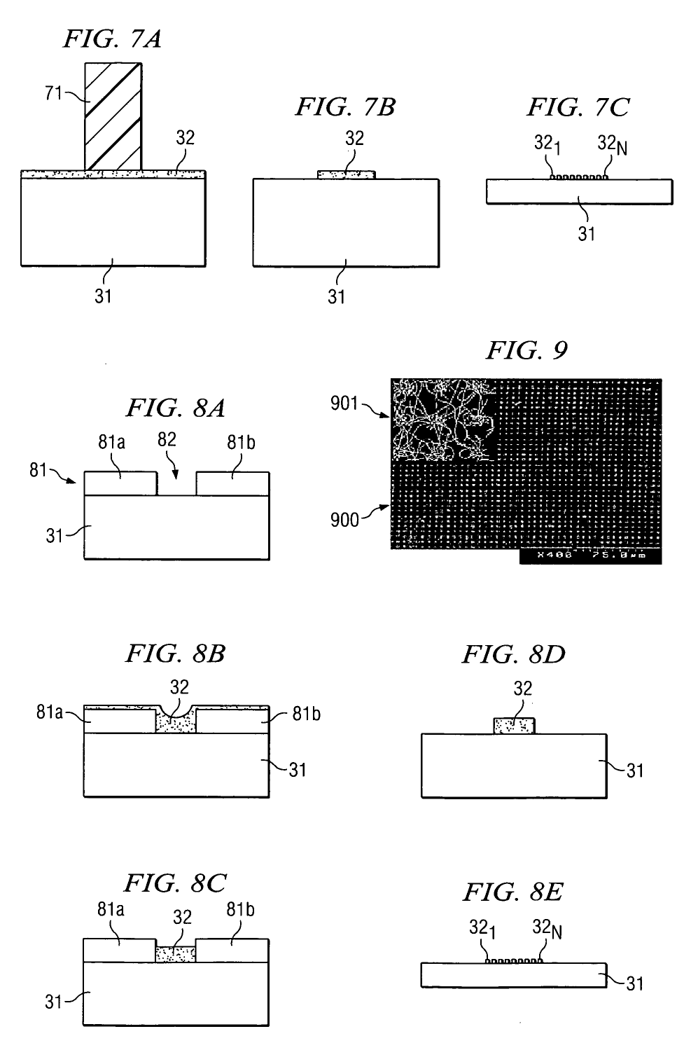

FIGS. 7A-7C show an exemplary scheme for generating catalyst cluster islands by patterning the catalyst-containing polymer film using any of the above-mentioned methods. As mentioned above, the patterning techniques control the size/distribution of the catalyst cluster islands, while the polymer self-assembly technique controls the size/distribution of the catalyst nanoparticles within each island. More particularly, in FIG. 7A, catalyst-containing polymer film 32 is deposited on substrate 31, just as in FIG. 3A described above. However, in FIG. 7A, a photoresist layer 71 is deposited on top of the film 32 and is patterned. Conventional photolithography is performed to remove the portions of the film 32 not covered by the patterned photoresist layer 71, and then the photoresist layer 71 is removed. The patterned catalyst-containing polymer film 32 remains on substrate 31 as shown in FIG. 7B. As described below, the portion 32 of the catalyst-containing polymer film remaining on substrate 31 in FIG. 7B is referred to as catalyst-containing polymer island That is, portion 32 of FIG. 7B is one exemplary catalyst-containing polymer island formed on substrate 31, and, as described further below, the photolithography process just described is typically used to form a plurality of such catalyst-containing polymer islands on substrate 31.

In the example shown in FIG. 7C, the above-described photolithography technique has been used to form patterned catalyst cluster islands 32₁, . . . , 32ₙ that do not contain organics. Such catalyst cluster islands are formed by removal of the organic portion of the polymer by ozonation or calcination. Such catalyst-containing polymer “islands” 32₁, 32₂, . . . , 32ₙ can each be formed in the manner described in FIGS. 7A-7B for forming island 32. That is, while photoresist layer 71 is shown for forming catalyst-containing polymer island 32 in FIGS. 7A-7B, such photoresist layer 71 is typically patterned to define a plurality (e.g., “n”) of areas covering the catalyst-containing film 32. In turn, such patterned photoresist layer 71 is typically used as described above for defining a plurality of catalyst-containing polymer islands 32₁, 32₂, . . . , 32ₙ. The size and distribution of the catalyst-containing polymer islands 32₁, 32₂, . . . , 32ₙ is controlled by the photolithography process, and the size and distribution of cluster nanoparticles within each of the cluster islands is controlled by self-assembly of the polymer carrier, as described above. Thereafter, nanostructures, such as CNTs, can be grown from the catalyst nanoparticles. As a result, catalyst location and nanostructure (e.g., CNT) location can be predetermined. This is the first manufacturable method for producing CNTs or other nanostructures.

Another exemplary approach that can be used to create patterned arrays of CNTs is shown in FIGS. 8A-8E. In this example, a base-soluble or organic soluble sacrificial layer, such as PMGI (polymethylglutarimide), is coated on the substrate (e.g., wafer) 31. The sacrificial layer is patterned by imaging a photoresist and then transferring the image into the sacrificial layer by either a wet or a dry etch. The photoresist is removed by selective solvent dissolution. As shown in the example of FIG. 8A, a sacrificial layer 81 is deposited on substrate 31, and is patterned into portions 81a and 81b having a recessed/removed area 82 between them. A block copolymer containing a complexed metal species (i.e., the vector polymer) 32 is then coated on top of the patterned sacrificial layer 81, as shown in FIG. 8B. The catalyst-containing block copolymer 32 is then annealed. Depending on properties of the sacrificial layer, the anneal step may cause the catalyst-containing block copolymer 32 to flow into the recessed area(s) 81, as shown in FIG. 8C. In other embodiments, portions of the block copolymer 32 residing on the sacrificial layer may not flow into the recessed area 81 (e.g., due to properties of the sacrificial layer used), but is instead removed by the process used to remove the underlying sacrificial layer 81. Continuing with the example shown in FIGS. 8A-8E, the sacrificial layer 81 is removed to leave the patterned catalyst-containing polymer 32 on substrate 31. UV-ozonation may be performed on the catalyst-containing polymer 32, as described above.

As shown in FIG. 8E, a plurality of such catalyst-containing polymer “islands” 32₁, 32₂, . . . , 32ₙ can be formed in the above-described manner. That is, while portions 81a and 81b having recessed area 82 therebetween are shown for forming island 32 in FIGS. 8A-8D, the sacrificial layer 81 may be patterned to include a plurality (e.g., “n”) of recessed areas 82, which in turn are used as described above for forming a plurality of catalyst-containing polymer “islands” 32₁, . . . , 32ₙ. The size and distribution of the catalyst-containing polymer islands 32₁, 32₂, . . . , 32ₙ is controlled by the photolithography process, and the size and distribution of nanoparticles formed from each of the catalyst-containing polymer islands is controlled by self-assembly of the polymer carrier, as described above. Thereafter, nanostructures, such as CNTs, can be grown from the catalyst nanoparticles on the substrate 31.

FIG. 9 shows exemplary SEM images of single-walled carbon nanotubes grown from patterned catalytic islands, such as islands 32₁-32ₙ of FIG. 8E, at low magnification (900) and high magnification (901). More specifically, FIG. 9 shows carbon nanotubes grown from catalyst islands that were produced from PS-b-PFEMS on a 75 mm wafer. Optical inspection of the grown nanotubes reveals that the solvent lift-off process (for removing the polymer template) completely removed all materials, leaving only the catalytic cluster islands behind. The SEM images in FIG. 9 depict arrays of carbon nanotubes grown from lithographically-defined 0.9 μm diameter catalytic cluster islands over a large surface area. There is no evidence of nanotube growth in the regions between the catalytic cluster islands, indicating that the lift-off process is a very effective means of generating a patterned catalyst substrate. Further, AFM and Raman analysis of the grown nanotubes indicated that the majority of the nanotubes have diameters of 1 nm or less.

While the catalyst-containing polymer film 32 is described as being patterned into catalyst-containing polymer islands in the above examples of FIGS. 7C and 8D, it should be recognized that the catalyst-containing polymer film may be patterned in any manner desired that is achievable using the above-described (or future developed) patterning techniques that are compatible with the catalyst-containing polymer film. For instance, catalyst-containing the polymer film 32 may be patterned into one or more catalyst-containing polymer islands and each of such catalyst-containing polymer islands may have any desired size, shape, and/or distribution achievable with the patterning technique being used. The above-described exemplary polymer film is compatible with such standard semiconductor fabrication techniques as an additive technique, such as the exemplary additive technique described in FIGS. 8A-8E) and a subtractive technique, such as the exemplary subtractive technique of FIGS. 7A-7C.

In view of the above, polymers, such as diblock copolymers, may be used as templates to produce various catalyst cluster islands or catalyt-containing polymer islands with controlled size and spacing for nanostructure (e.g., carbon nanotube) growth. Periodically ordered catalytic nanostructures can be generated by spin coating polymer-based catalyst systems. As a result, uniformly distributed, low-defect density single-walled nanotubes(CNTs) have been obtained. CNTs with diameters of 1 nm or less have been produced from iron-containing inorganic nanostructures using conventional CVD. The superior film-forming ability of polymer-based catalyst systems enables selective growth of carbon nanotubes on lithographically predefined catalyst islands over a large surface area. This ability to control the density and location of CNTs offers great potential for practical applications.

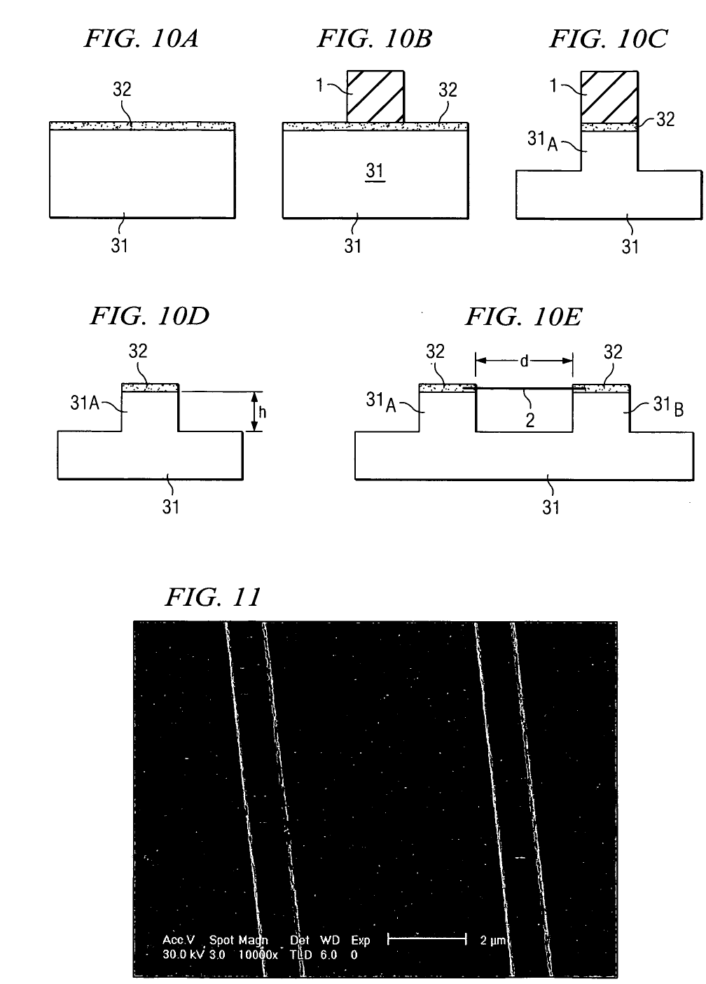

The use of photolithography techniques with the polymer film of embodiments of the present invention is not limited in application to those examples described above with FIGS. 7-8. Because such polymer film is compatible with photolithography techniques, various applications other than forming catalyst cluster islands may be performed. For instance, in certain embodiments, the polymer film may be processed using photolithography to enable formation of suspended nanostructures, such as suspended CNTs. An example of a technique for forming such suspended CNTs is shown in FIGS. 10A-10E.

In this example, catalyst-containing block copolymer 32 is deposited on substrate 31 (FIG. 10A). Photoresist material 1 is deposited and patterned (FIG. 10B), and a deep etch is performed into the substrate 31, forming a mesa 31_{A} (FIG. 10C) that extends from the substrate's surface. Such etch is typically performed to form a plurality of mesas on substrate 31, such as mesas 31_{A} and 31_{B} described below with reference to FIG. 10E. The photoresist is removed by selective solvent dissolution, and the catalyst-containing block copolymer 32 is then annealed and oxidation is performed on the catalyst-containing polymer 32, as described above (FIG. 10D). Thus, the catalyst nanoparticles arranged according to the self-assembly of polymer 32 are located on the top of mesa 31_{A}, at a height above the substrate surface defined by the depth of the etch performed into substrate 31. In one embodiment, height h of mesa 31_{A} is approximately 0.4 μm.

Then, nanostructures, such as CNTs, are grown from the catalyst nanoparticles. Some of the CNTS grow from the top of one mesa 31_{A} to the top of an adjacent mesa 31_{B}, such as suspended CNT 2 shown in FIG. 10E. FIG. 11 shows an SEM image of suspended CNTs obtained by the exemplary technique of FIGS. 10A-10E. The distance d between adjacent mesas 31_{A} and 31_{B} is set to enable CNTs to grow across the valley between such mesas. Initial experiments have shown that CNTs are capable of growing across a valley of at least distance d=0.5 micrometers to form suspended CNTs coupled between two mesas. By controlling the arrangement of catalyst nanoparticles on the surfaces of mesas 31_{A} and 31_{B} via the polymer self-assembly techniques described herein, the locational arrangement of suspended CNTs can be controlled. For instance, a series of suspended CNTs may be formed, similar to lines commonly found on telephone poles. In certain embodiments, known techniques for influencing the direction of growth of CNTs are employed to encourage such CNTs to grow from one mesa toward another mesa. Of course, while FIGS. 10A-10E provide yet another exemplary application that illustrates the compatibility of the polymer techniques described herein with photolithography techniques, embodiments of the present invention are not limited to any such application.

1. A method comprising:
including in at least one block of a block copolymer a catalyst species for growing a nanostructure;
depositing said block copolymer onto a substrate; and
causing said block copolymer to self-assemble into a structure.

2. The method of claim 1 further comprising:
forming catalyst nanoparticles from the catalyst species in the structure.

3. The method of claim 2 wherein said structure defines at least one of size and distribution of said catalyst nanoparticles.

4. The method of claim 3 wherein said distribution is characterized by spacing between the catalyst nanoparticles, said spacing defined by said structure.

5. The method of claim 2 further comprising:
growing nanostructures from said catalyst nanoparticles.

6. The method of claim 1 further comprising:
patterning the block copolymer deposited on the substrate.

7. The method of claim 6 wherein said patterning comprises:
forming an island of said block copolymer on said substrate.

8. The method of claim 1 further comprising:
forming the block copolymer by attaching said catalyst species to a repeat unit of the block copolymer.

9. The method of claim 8 wherein said attaching said catalyst species comprises:
complexation, complexating said catalyst species with pyridine units of polystyrene-b-poly(vinyl pyridine) (PS-b-PVP).

10. The method of claim 9 wherein said catalyst species comprises iron.

11. The method of claim 1 further comprising:
forming the block copolymer via direct synthesis.

12. The method of claim 11 wherein said forming comprises:
directly synthesizing polystyrene-b-poly(ferrocenylethylmethylsilane) (PS-b-PFEMS).

13. The method of claim 12 wherein said directly synthesizing comprises:
performing a sequential living polymerization of a nonmetal-containing styrene block of said block copolymer followed by a catalyst-containing block of ferrocenylethylmethylsilane to form said PS-b-PFEMS.

14. The method of claim 1 wherein said catalyst species comprises a metal.

15. The method of claim 1 wherein said catalyst species comprises a transition metal.

16. The method of claim 1 further comprising:
controlling volumetric ratio of said at least one block containing said catalyst species within said block copolymer to define said structure.

17. A method comprising:
providing a block copolymer comprising a catalyst payload in fewer than all blocks thereof;
depositing said block copolymer onto a substrate;
causing said block copolymer to self-assemble into a structure defining at least the distribution of said catalyst payload on said substrate;
removing components of the block copolymer to leave the catalyst payload on said substrate in an arrangement defined by said structure.

18. The method of claim 17 wherein said removing comprises:
removing organic components of the block copolymer.

19. The method of claim 17 wherein said removing comprises:
performing UV-ozonation.

20. The method of claim 17 wherein said structure further controls the size of said nanoparticles of the catalyst payload.

21. The method of claim 17 wherein said catalyst payload comprises catalyst species carried by said copolymer, and wherein the self-assembly of said block copolymer forms said nanoparticles from said catalyst species.

22. The method of claim 21 further comprising:
growing nanostructures from said nanoparticles.

23. The method of claim 17 further comprising:
patterning the block copolymer deposited on the substrate.

24. The method of claim 23 wherein said patterning comprises:
forming an island of said block copolymer on said substrate.

25. A method comprising:
determining a volumetric ratio of a first block of a block copolymer to a total of blocks of the block copolymer for forming a structure;
including in said first block a catalyst species for growing a nanostructure;
depositing on a substrate the block copolymer having the determined volumetric ratio; and
annealing the block copolymer to cause the first block to self-assemble into said structure.

26. The method of claim 25 further comprising:
patterning the block copolymer deposited on the substrate.

27. The method of claim 25 wherein the structure into which said block copolymer self-assembles controls at least one of size and distribution of said nanoparticles.
